(19) United States
(12) Patent Application Publication
(10) Pub. No.: US 2025/0055284 A1
(43) Pub. Date: Feb. 13, 2025

(54) WEAKLY-CENTRALIZED FREQUENCY REGULATION CONTROL METHOD OF CHARGE STATION CLUSTER BASED ON VIRTUAL LEADER AND MEDIUM

(71) Applicant: WUHAN UNIVERSITY, Hubei (CN)

(72) Inventors: Jun YANG, Hubei (CN); Song KE, Hubei (CN)

(73) Assignee: WUHAN UNIVERSITY, Hubei (CN)

(21) Appl. No.: 18/406,179

(22) Filed: Jan. 7, 2024

(30) Foreign Application Priority Data
Aug. 10, 2023 (CN) 202311008305.2

(51) Int. Cl. H02J 3/40; H02J 3/32

(52) U.S. Cl. CPC H02J 3/40; H02J 3/322; H02J 2203/20; H02J 2300/40

(57) ABSTRACT

The present disclosure provides a weakly-centralized frequency regulation control method of a charge station cluster based on virtual leader and a medium. Firstly, based on the control strategy of the virtual synchronous generator and the requirements of the electric vehicles and the charge stations, an architecture of the virtual synchronous generator of the electric vehicles and the charge stations is established. Secondly, based on the control strategy of the collaborative topology design of multiple charge stations, a virtual leader is determined and a weakly-centralized consistency algorithm is designed. Finally, a control strategy of the collaborative frequency regulation of the charge station cluster is proposed to achieve the weakly-centralized frequency regulation control of the charge station cluster.

### CROSS-REFERENCE TO RELATED APPLICATION

This application claims the priority benefit of China application serial no. 202311008305.2, filed on Aug. 10, 2023. The entirety of the above-mentioned patent application is hereby incorporated by reference herein and made a part of this specification.

### BACKGROUND

### Technical Field

The present disclosure relates to the application field of power systems and frequency regulations (FR), and in particular to a weakly-centralized frequency regulation control system of a charge station cluster based on virtual leader.

### Description of Related Art

In recent years, along with rapid development of new energy and energy storage technologies, the new energy generation and grid connection capacity ratio gradually increases, leading to gradual decrease of the inertia of the power systems and weakening the capability of the power grids against power shortage and frequency fluctuation. Along with continuous decrease of online ratio of the thermal power units, high-ratio renewable energy, high power-electronization and low inertia will become important features of the future power systems of China. It is necessary to introduce better frequency regulation resources to replace the inertia support and primary frequency regulation capability brought about by the decreased thermal power, so as to mitigate the problem of the frequency stability and electric energy quality of the power grids in the context of large-scale grid connection of the renewable energy.

Micro-grid, as a power distribution network formed by distributed power sources, loads and energy storages, can achieve autonomous operation as an off grid and grid-connected operation as a controllable unit, which is one of the technical approaches for realizing the plug and play of the distributed power sources as well as an important part of the future power grids.

In the micro-grid, the distributed power sources such as wind power, photovoltaic power and energy storage and the like and controllable loads such as electric vehicles and the like all can access the power grid by a power electronic conversion device, such that the inertia level of the micro-grid decreases significantly. During grid-connected operation of the micro-grid, it can be seen as a controllable unit to accept scheduling control of the power grid; when the micro-grid operates autonomously in islanded mode, it is worthwhile to conduct deep research on its stability problem. After being impacted by a same power unbalance amount, the frequency deviation of the islanded micro-grid increases and the frequency change rate also increases, lowering its disturbance resistance. The grid-forming inverter control is a control mode for supporting the islanded operation of the micro-grid. The virtual synchronous generator control is widely applied due to the characteristics of being externally equivalent to synchronous generator and hence mitigates the stability problem brought by the weak inertia support to the micro-grid.

Because the capacity of the micro-grid is limited and its frequency regulation resources are relatively in shortage, it is increasingly difficult to maintain the frequency stability of the micro-grid only by the traditional adjustment approach. The flexible loads such as electric vehicles accessing the micro-grid have strong randomness, which will further threaten the operation stability of the micro-grid. The electric vehicles are typical controllable flexible loads, and a number and a capacity of controllable electric vehicles within a single charge station are highly random. If aggregation can be performed on the electric vehicles and the charge stations by a corresponding technical control approach and collaborative participation in frequency control of the micro-grid is further carried out, the frequency regulation range of the charge station cluster can be effectively increased and the frequency stability level of the micro-grid can also be improved. Therefore, in order to increase the inertia support and the active frequency regulation capability of the islanded micro-grid and mine the frequency regulation capability of the electric vehicles, it is required to conduct research on weakly-centralized frequency regulation control technology of the charge station cluster to achieve collaborative aggregation within the charge station cluster and thus improve the dynamic characteristics of the frequency.

### SUMMARY

In order to solve the above problems, the present disclosure provides a weakly-centralized frequency regulation control system of a charge station cluster based on virtual leader. Firstly, a virtual synchronous generator control architecture of the charge stations is designed, and in combination with an adjustable power range of the charge stations, and a control strategy of a charge power response of the electric vehicles in the charge stations, a real-time charge and discharge power allocation algorithm for each electric vehicle in the charge stations is proposed. Further, based on a collaboration topology of multiple charge stations and the control policy, a virtual leader consistency algorithm is designed. Finally, a control system of a collaborative frequency regulation of the charge station cluster is proposed.

Depending on the actual engineering, the present disclosure can be applied to the design of charge station cluster aggregation and frequency response control system under different scales.

The technical solutions of the present disclosure are described below.

A weakly-centralized frequency regulation control method of a charge station cluster based on virtual leader, comprising:

collecting data of wind power, photovoltaic and random load systems, comprising real-time outputs of wind power, photovoltaic, resident loads and each charge station within a controlled region;

at the time of occurrence of disturbance, based on a virtual synchronous generator control architecture of the charge stations, in accordance with a consistency protocol and virtual leader algorithm, executing, by the charge station cluster, control algorithm to update a control input of each charge station VSG, collaboratively allocate a frequency regulation response power in each charge station VSG, and update a state amount of each charge station VSG including a charge and discharge power, a collaborative variable of frequency regulation cost rate, and a collaborative variable of power capacity coefficient;

based on frequency restoration, determining whether a stable state is achieved; when the system frequency is restored to stable, outputting the collaborative variables of each charge station and the frequency regulation power of each charge station.

A control strategy of a virtual synchronous generator (VSG) of the charge stations is defined as comprising a control strategy of a rotor motion equation and an electromagnetic transient equation of the synchronous generator, which specifically comprises the followings: after receiving a Pₘ input power instruction, the VSG determines, by a torque equation, a rotational angular velocity of a virtual rotor, and performs subtraction operation on the rotational angular velocity and a rated rotational angular velocity ω_{N} to obtain an angular acceleration of a virtual power angle δ, and obtains the virtual power angle by integration, wherein based on power angle characteristics, the output power Pₑ of the VSG is calculated in the following formula:

$${P}_{e} = \frac{{E}_{0} U}{{X}_{f}} sin δ$$

wherein E₀ is a no-load electromotive force of the VSG, U is an output end voltage of the VSG, and X_{f} is a filtering reactance.

The charge stations VSG are involved in frequency regulation and an EV-f controller feedback compensation step is added to a power-frequency controller to correct a reference value of a VSG input mechanical power, which specifically comprises the followings:

$${P}_{m} = {P}_{ref} + Δ {P}_{ev - f}$$

wherein Pₘ is a master frequency regulation instruction of the charge station VSG; P_{ref} is a rated power at the time of no consideration of frequency regulation, and ΔP_{ev-f} is a compensation power output by the EV-f controller feedback compensation step,

ΔP_{ev-f} is valued in the range of [ΔP_{ev-fmin}, ΔP_{ev-fmax}], and ΔP_{ev-fmin} and

ΔP_{ev-fmax} are calculated in the following formulas:

$${P}_{e v − f min} ( τ ) = {\sum }_{i = 1}^{N} {P}_{i}^{+} ( τ ) , ∀ τ$$

$${P}_{ev − f max} ( τ ) = {\sum }_{i =}^{N} {P}_{i}^{−} ( τ ) , ∀ τ$$

A collaborative topology design control method of the consistency protocol among multiple charge stations comprises:

establishing a second-order agent system of the charge stations;

establishing collaborative variables, comprising a power capacity coefficient and a relative frequency regulation cost coefficient, and defining a frequency regulation cost and a relative frequency regulation cost coefficient of an electric vehicle;

designing a consistency protocol and executing control based on the designed consistency protocol.

In the second-order agent system, it is aimed to enable the collaborative variable of frequency regulation cost rate of the charge stations to be same as the collaborative variable of power capacity coefficient, and achieve frequency regulation of the power grid; one virtual charge station is taken as leader, desired states k_{c0} and k_{pq0} are pre-defined, other n charge stations in a network are referred to as followers, and a secondary frequency regulation response power is allocated among the charge stations based on frequency regulation cost and a controllable capacity, which specifically comprises:

based on a system frequency state, updating, by a power grid scheduling center, desired states p₀ and q₀ of the leader;

based on the input of the designed consistency collaborative control, enabling the state variables of the followers in the system to follow the state of the leader through a topological network.

The collaborative variables comprise a power capacity coefficient k_{pqi} and a relative frequency regulation cost coefficient k_{ci}, wherein,

the power capacity coefficient k_{pqi}

$${k}_{p q i} = {p}_{i} / {q}_{i} , {k}_{pq 0} = {P}_{N} / {\sum }_{j = 1}^{n} {q}_{j}$$

relative frequency regulation cost coefficient

$${k}_{c i} ( t ) = [ cos {t}_{c s , i} ( t ) − \frac{1}{n} {\sum }_{i = 1}^{n} cos {t}_{c s , i} ( t ) ] / {\sum }_{i = 1}^{n} cos {t}_{c s , i} ( t ) , {k}_{c 0} = 0$$

wherein k_{pq0} is a power capacity coefficient of the virtual leader, which means an average value of the power capacity coefficients at the time of collaboration of n charge stations, P_{N} is a master frequency regulation power instruction for collaboration of the charge stations as well as an input of the consistency collaboration control algorithm, pᵢ is a real-time power of the i-th charge station, qi is a controllable capacity of the i-th charge station, k_{pqi} is a power capacity coefficient of the i-th charge station, k_{ci} is a relative frequency regulation cost coefficient of the i-th charge station, k_{c0} is a relative frequency regulation cost coefficient of the virtual leader, n is a number of the charge stations in the charge station cluster, cost_{cs,i} is a frequency regulation cost rate of the i-th electric vehicle charge station, cost_{cs,i} is a frequency regulation cost rate, P_{k,i}^{cha} is a charge power of EVk in the i-th charge station, SoCₖ^{emin} and SoCₖ^{emax} are desired SoC upper limit and lower limit of EVk in the i-th charge station, Ek_{k,i}ⁿ is battery rated capacity of EVk in the i-th charge station, Kᵢ is a total number of adjustable EVs in the i-th charge station, k_{c0} is a relative FR cost rate of the virtual leader, which is valued 0, which means providing a reference value of the frequency regulation cost rate in the collaboration of n charge stations.

The frequency regulation cost cost_{cs,i}(t) of the electric vehicle is calculated as follows:

$$cos {t}_{c s , i} ( t ) = {\sum }_{k = 1}^{{K}_{i}} \frac{{P}_{max} − {P}_{k , i}^{cha} ( t )}{( {SoC}_{k , i}^{max} − So {C}_{k , i}^{min} ) {E}_{k , i}^{n}}$$

wherein cost_{cs,i} is a frequency regulation cost rate, P_{k,i}^{cha} is a charge power of EVk in the i-th charge station, SoCₖ^{emin} and SoCₖ^{emax} are desired SoC upper limit and lower limit of EVk in the i-th charge station, E_{k,i}ⁿ is a battery rated capacity of EVk in the i-th charge station, and Kᵢ is a total number of adjustable EVs in the i-th charge station.

Based on the power capacity coefficient k_{pq} and the relative FR cost rate k_{c}, the following consistency control protocol is established:

$${u}_{i} ( t ) = {\sum }_{j = 1}^{n} {a}_{ij} ( sign ( {k}_{p q i} ( t ) − {k}_{pqj} ( t ) ) ) − {g}_{i} ( sign ( {k}_{p q i} ( t ) − {k}_{pq 0} ( t ) ) ) - α {P}_{N} {\sum }_{j = 1}^{n} {a}_{ij} ( sign ( {k}_{cj} ( t ) − {k}_{ci} ( t ) ) ) − {g}_{i} ( sign ( {k}_{c 0} ( t ) − {k}_{c i} ( t ) ) )$$

wherein sign(.) represents a symbol function, a is a control gain, k_{co}(t)=0 for α=2, P_{N} is a master FR power instruction for collaboration of the charge stations as well as an input of the collaborative control; the consistency of the control algorithm is embodied in maintaining a ratio of the power capacity coefficient as consistent after frequency stabilization, such that the total frequency regulation cost in the frequency restoration process is minimized; aᵢⱼ represents whether the 0-1 logic variable is communicably collaborated between the i-th charge station and the j-th charge station; in case of collaboration, aᵢⱼ=1 and otherwise aᵢⱼ=0; gᵢ represents whether the i-th charge station receives state information of the virtual leader; if yes, gᵢ=1, and otherwise gᵢ=0. k_{pqi} is a power capacity coefficient of the i-th charge station, k_{pq0} is a power capacity coefficient of the virtual leader, k_{ci} is a relative frequency regulation cost coefficient of the i-th charge station, k_{c0} is a relative frequency regulation cost coefficient of the virtual leader, wherein when x>0, sign(x)=1; when x=0, sign(x)=0; when x<0, sign(x)=−1.

A non-transient computer readable storage medium, storing a computer program,

wherein the computer program is executed by a processor to perform the control method.

A computer program product, comprising a computer program, wherein the computer program is executed by a processor to perform the control method.

Therefore, the present disclosure has the following advantages: under the consistency protocol, all charge stations in a distributed network collaborate with adjacent charge stations, and finally reach consensus on the values of the relative frequency regulation cost rate k_{ci} and the power capacity coefficient k_{pqi}. In this way, the frequency regulation cost of the charge stations can be reduced and the accuracy of the frequency regulation power allocation can be improved. The proposed frequency regulation control structure of the charge station cluster can achieve weakly-centralized aggregation control so as to improve the dynamic characteristics of the power grid frequency. Furthermore, the management on the charge load of the electric vehicles and the control capability of the charge stations can be enhanced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a topological structure of a virtual synchronous generator of a charge station.

FIG. 2 is an electric amount and a charge and discharge power of EV in a charge station.

FIG. 3 is an electric amount and a power boundary of EV at the time of Eᵢ^{min}≤0.

FIG. 4 is an electric amount and a power boundary of EV at the time of Eᵢ^{min}≥0.

FIG. 5 is a weakly-centralized frequency regulation control system of a charge station cluster.

FIG. 6 is a collaborative topology of a charge station cluster.

FIG. 7 is a flowchart of a virtual leader consistency algorithm.

FIG. 8 is a converging process of the power capacity coefficient k_{pqi}.

FIG. 9 is a converging process of the frequency regulation cost coefficient k_{ci}.

FIG. 10 is a restoration process of a micro-grid frequency.

FIG. 11 is a trend of a total frequency regulation cost of charge stations.

FIG. 12 is a response power of each charge station.

### DESCRIPTION OF THE EMBODIMENTS

The technical solutions of the present disclosure will be specifically described below in combination with specific embodiments and accompanying drawings 1 to 7.

### Embodiment 1

A first embodiment of the present disclosure is described below.

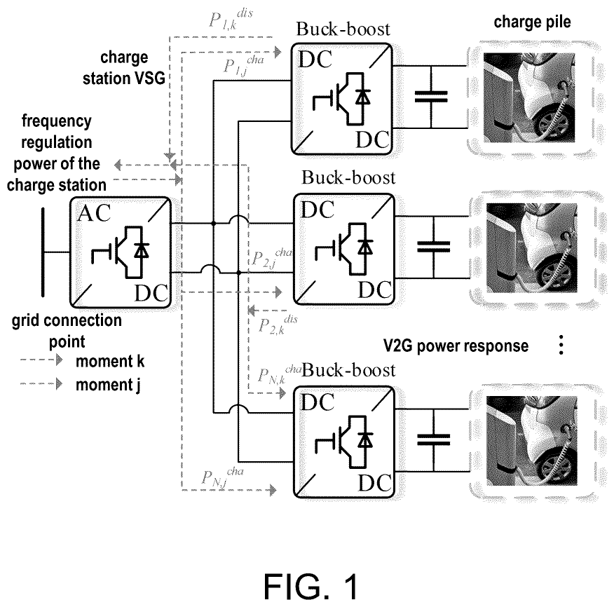

At step 1: a virtual synchronous generator control architecture of charge stations is designed, which, as shown in FIG. 1, specifically includes the followings:

A control strategy of a virtual synchronous generator (VSG) is defined as introducing a rotor motion equation and an electromagnetic transient equation of the synchronous generator into an inverter grid-connection control policy.

A torque equation in the rotor motion equation is:

$$\{ \begin{matrix}{T}_{m} - {T}_{e} - {T}_{D} = J {\frac{d ω}{dt}}^{} \\ {T}_{m} = \frac{{P}_{m}}{{ω}_{N}} \\ {T}_{e} = \frac{{P}_{e}}{{ω}_{N}} \\ {T}_{D} = D ( ω - {ω}_{N} ) = D Δω\end{matrix}$$

Therefore, after receiving a Pₘ input power instruction, the VSG determines, by the above torque equation, a rotational angular velocity of a virtual rotor, and performs subtraction operation on the rotational angular velocity and a rated rotational angular velocity ω_{N} to obtain an angular acceleration of a virtual power angle δ, and obtains the virtual power angle by integration. The grid connection of the inverter through a filtering circuit is similar to the grid connection of the synchronous generator through internal impedance. Therefore, based on the power angle characteristics, the output power Pₑ of the VSG can be calculated in the following formula:

$${P}_{e} = \frac{{E}_{0} U}{{X}_{f}} sin δ$$

where E₀ is a no-load electromotive force of the VSG, U is an output end voltage of the VSG, and X_{f} is a filtering reactance.

For involving the charge stations VSG in frequency regulation, an EV-f controller feedback compensation step is added to a power-frequency controller to correct a reference value of a VSG input mechanical power, as shown in the following formula:

$${P}_{m} = {P}_{ref} + {D}_{p} ( {ω}_{N} - ω )$$

where P_{ref} is a reference value of an active power, and Dₚ is a droop coefficient.

For the characteristics of the EV charge stations, a secondary no-deviation frequency regulation controller EV-f controller is designed to introduce an EV frequency regulation capability into the frequency deviation feedback instruction as feed-forward compensation of the VSG active-frequency controller. Thus, the secondary frequency control of the VSG is based on the following formula:

$${P}_{m} = {P}_{ref} + Δ {P}_{ev - f}$$

where ΔP_{ev-f} is a feedback compensation power for frequency control of the charge stations.

At step 2, as a further step, it is required to analyze the influence of the EV requirements on the control power range of the charge stations. The output Pₘ of the VSG is mainly limited by the factors such as the charge requirements of each electric vehicle in the charge stations, i.e. ΔP_{ev-fmin} and ΔP_{ev-fmax}.

From the angle of frequency regulation, the electric vehicles can serve as mobile storage devices to take the regulation task. Thus, Taking the regulation task properly is the control target of the V2G strategy for the electric vehicles to participate in secondary frequency regulation of the micro-grid. On the other hand, since the users use EV for transportation, the SoC and charge power of the EV are also limited to some extent.

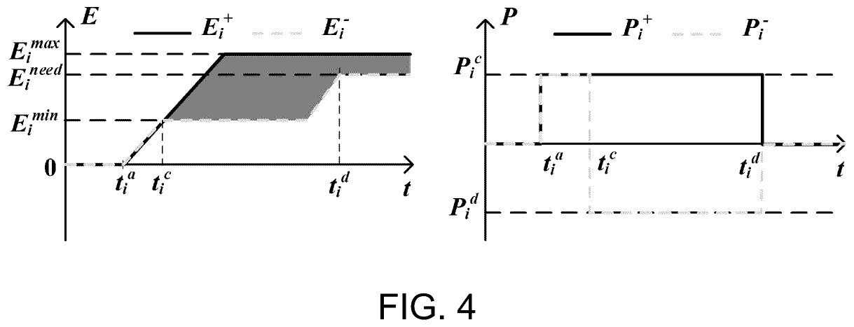

After the EV is connected to a charge pile of the charge stations, its state of charge and charge and discharge power have the ranges as shown in FIG. 4, where Eᵢⁱⁿⁱ, Eᵢ^{end}, Eᵢ^{min}, Eᵢ^{max} are initial, terminating, minimum and maximum electric amounts of the i-th EV, and Pᵢ^{c} and Pᵢ^{d} are charge and discharge powers of the i-th EV.

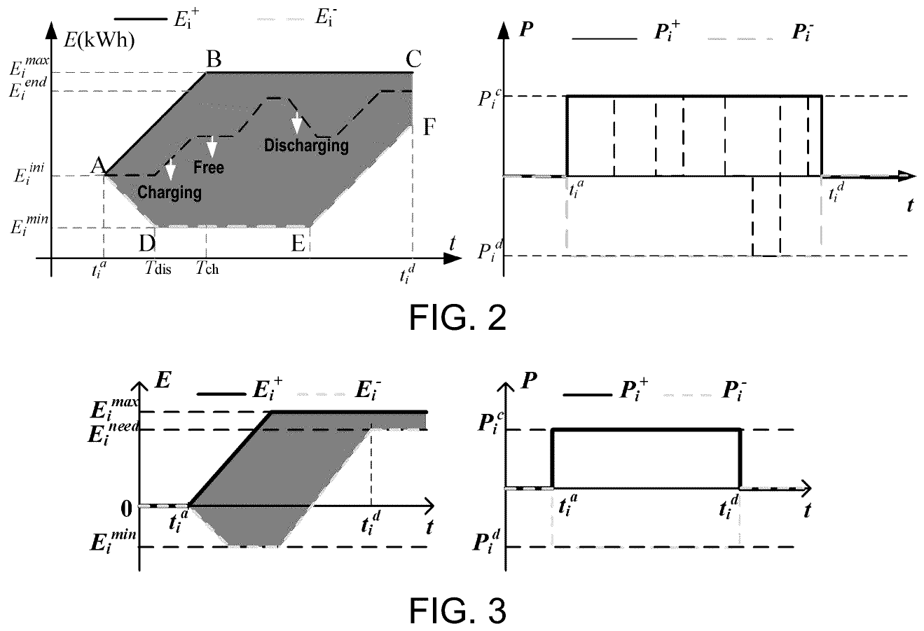

When an EV stays in a charge station for a desired time length greater than its charge time and the EV allows the minimum electric amount to be less than the initial electric amount Eᵢ^{min}≤Eᵢⁱⁿⁱ, the EV has a charge and discharge capability. Its electric energy and power boundary are as shown in FIG. 2 and satisfy the following formulas:

$${E}_{i}^{+} ( τ ) = \{ \begin{matrix}{E}_{i}^{+} ( {t}_{i}^{d} ) , τ > {t}_{i}^{d} \\ min ( {E}_{i}^{+} ( τ - 1 ) + {P}_{i}^{c} {η}^{c} Δ t , {e}_{i}^{max} ) , {t}_{i}^{a} < τ \leq {t}_{i}^{d} \\ 0 , τ \leq {t}_{i}^{a}\end{matrix}$$

$${E}_{i}^{-} ( τ ) = \{ \begin{matrix}{E}_{i}^{need} , τ > {t}_{i}^{d} \\ max ( {E}_{i}^{-} ( τ - 1 ) + {P}_{i}^{d} Δ t / {η}^{d} , {E}_{i}^{min} , {E}_{i}^{need} - \\ {P}_{i}^{c} {η}^{c} ( {t}_{i}^{d} - τ ) Δ t ) , {t}_{i}^{a} < τ \leq {t}_{i}^{d} \\ 0 , τ \leq {t}_{i}^{a}\end{matrix}$$

$${P}_{i}^{+} ( τ ) = \{ \begin{matrix}0 , τ > {t}_{i}^{d} or τ \leq {t}_{i}^{a} \\ {P}_{i}^{c} {η}^{c} , {t}_{i}^{a} < τ \leq {t}_{i}^{d}\end{matrix}$$

$${P}_{i}^{-} ( τ ) = \{ \begin{matrix}0 , τ > {t}_{i}^{d} or τ \leq {t}_{i}^{a} \\ {P}_{i}^{d} {η}^{d} , {t}_{i}^{a} < τ \leq {t}_{i}^{d}\end{matrix}$$

where η^{c} and η^{d} are charge and discharge efficiencies of the EV, Eᵢ⁺ and Eᵢ⁻ are charge and discharge boundaries of the i-the EV, Pᵢ^{c} and Pᵢ^{d} are charge and discharge powers of the i-the EV, Pᵢ⁺ and Pᵢ⁻ are charge and discharge power boundaries of the i-the EV, tᵢ^{a} and tᵢ^{d} are arrival and departure moments of the i-the EV, and τ is a current moment.

When Eₜ^{min}≤Eᵢⁱⁿⁱ, the EV i can start to perform charge or discharge to the power grid at a moment tᵢ^{a}; when Eₜ^{min}≥Eₜⁱⁿⁱ, EVi needs to be charged to Eₜ^{min} from the moment tᵢ^{a} to the moment tᵢ^{c} with the maximum power, and then perform charge and discharge. Its electric energy and power boundary are as shown in FIGS. 3 and 4.

Therefore, by the above method, the controllability of the EVs in the charge stations can be determined and further, the controllable capacities of the EVs in the charge stations are aggregated as shown in the following formulas.

$${E}_{s}^{+ / -} ( τ ) = {\sum }_{i = 1}^{N} {E}_{i}^{+ / -} ( τ ) , ∀ τ$$

$${P}_{s}^{+ / -} ( τ ) = {\sum }_{i = 1}^{N} {P}_{i}^{+ / -} ( τ ) , ∀ τ$$

where Eₛ⁺ and Eₛ⁻ are charge and discharge amount boundaries of the charge stations, Pₛ⁺ and Pₛ⁻ are charge and discharge power boundaries of the charge stations, and N is a number of the EVs in the charge stations.

From the user requirements and SoC of the electric vehicles, the above modeling and

aggregation model of the electric vehicles combine the charge powers and capacities of the electric vehicles in a charge station with the stop times to obtain the energy and power boundaries of the electric vehicles for participation in VSG frequency regulation, and further under the precondition of satisfying each EV charge requirement, obtain the controllable power and capacity of the EVs aggregated together in the entire charge station. Moreover, based on the parameters such as charge pile power in the charge station, the value range of the ΔP_{ev-f} provided for control of the charge station VSG is [ΔP_{ev-fmin}, ΔP_{ev-fmax}].

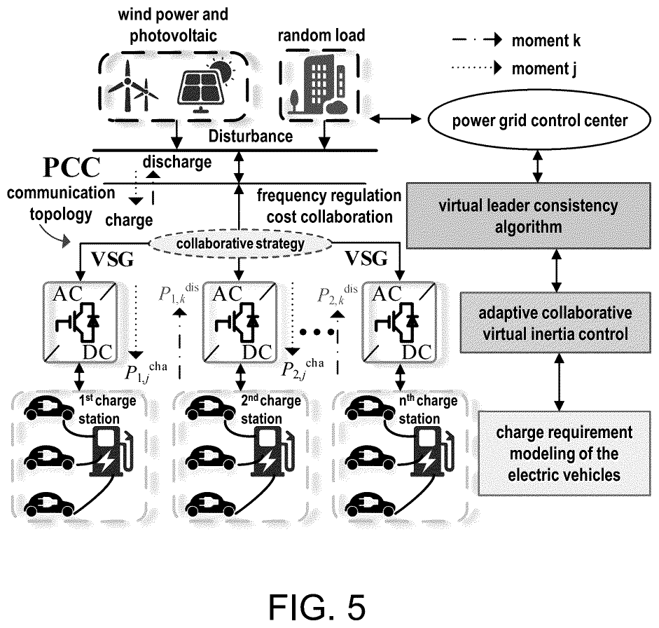

At step 3, a control strategy is designed based on a collaborative topology among multiple charge stations, a virtual leader is determined and a weakly-centralized consistency algorithm is designed, as shown in FIG. 5.

Firstly, a second-order agent system of the charge stations is established as below:

$${\dot{q}}_{i} ( t ) = {p}_{i} ( t )$$

$${\dot{p}}_{i} ( t ) = {u}_{i} ( t ) ,$$

$$i = 1 , 2 , … , n$$

where qᵢ is a controllable capacity of the i-th charge station, pᵢ is a real-time power of the i-th charge station, and uᵢ(t) is a control input of the charge station.

Secondly, a collaborative variable is established.

(1) Power capacity coefficient k_{pqi}

$${k}_{pqi} = {p}_{i} / {q}_{i} ,$$

$${k}_{pq 0} = {P}_{N} / {\sum }_{j = 1}^{n} {q}_{j}$$

where k_{pq0} is a power capacity coefficient of the virtual leader, which means an average value of the power capacity coefficients of n charge stations, P_{N} is a master frequency regulation power instruction for collaboration of the charge stations, as well as an input of the consistency collaboration control algorithm.

(2) Relative frequency regulation cost coefficient k_{ci}

The frequency regulation cost cost_{cs,i(}t) of the electric vehicles is defined as follows:

$${cost}_{cs , i} ( t ) = {\sum }_{k = 1}^{{K}_{i}} \frac{{P}_{max} - {P}_{k , i}^{cha} ( t )}{( {SoC}_{k , i}^{max} - {SoC}_{k , i}^{min} ) {E}_{k , i}^{n}}$$

where cost_{cs,I} is a frequency regulation cost factor, P_{k,i}^{cha} is a charge power of EVk in the i-th charge station, SoCₖ^{emin} and SoCₖ^{emax} are desired SoC upper limit and lower limit of EVk in the i-th charge station, E_{k,i}ⁿ is a battery rated capacity of EVk in the i-th charge station, and Ki is a total number of adjustable EVs in the i-th charge station.

Further, the relative frequency regulation cost coefficient is obtained as follows:

$${k}_{ci} ( t ) = [ {cost}_{i} ( t ) - \frac{1}{n} {\sum }_{i = 1}^{n} {cost}_{i} ( t ) ] / {\sum }_{i = 1}^{n} {cost}_{i} ( t ) , {k}_{c 0} = 0$$

where k_{c0} is a relative FR cost rate of the virtual leader, valued 0, which means a reference value of the frequency regulation cost rate provided for collaboration of n charge stations.

Finally, a consistency protocol is designed.

There is a linear relationship between pᵢ and k_{ci}, k_{pqi}, and the FR response power of the single charge stations is positively proportional to respective controllable capacities qᵢ and is in collaboration with the relative frequency regulation cost rate. Therefore, based on the power capacity coefficient k_{pq} and the relative FR cost rate k_{c}, the following consistency control protocol is established.

$${u}_{i} ( t ) = {\sum }_{j = 1}^{n} {a}_{ij} ( sign ( {k}_{pqi} ( t ) - {k}_{pqj} ( t ) ) ) - {g}_{i} ( sign ( {k}_{pqi} ( t ) - {k}_{pq 0} ( t ) ) ) - α {P}_{N} {\sum }_{j = 1}^{n} {a}_{ij} ( sign ( {k}_{cj} ( t ) - {k}_{ci} ( t ) ) ) - {g}_{i} ( sign ( {k}_{c 0} ( t ) - {k}_{ci} ( t ) ) )$$

where sign(.) represents a symbol function, α is a control gain, k_{c0}(t)=0 for α=2, P_{N} is a master FR power instruction for collaboration of the charge stations as well as an input of the collaborative control. The consistency of the control algorithm is embodied in maintaining a ratio of the power capacity coefficient as consistent after frequency stabilization, such that the total frequency regulation cost in the frequency restoration process is minimized.

At step 4, a control strategy of a collaborative frequency regulation of the charge station cluster is proposed.

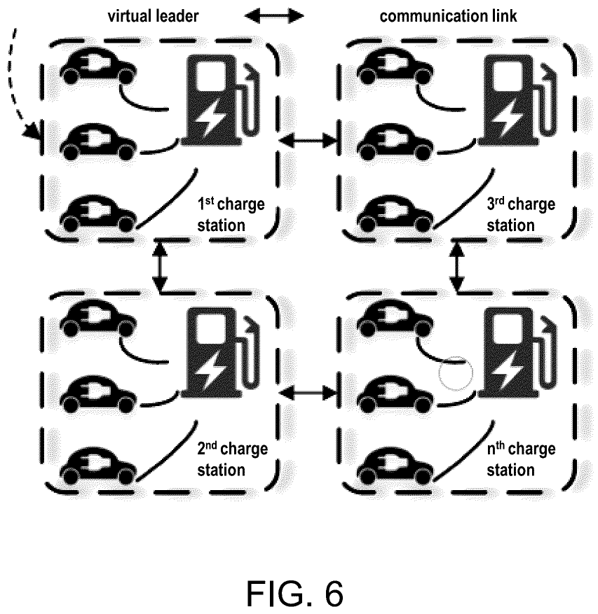

In a secondary control, the control target is to enable the collaborative variables k_{ci}(t) and k_{pqi}(t) of the charge stations to be same, and achieve frequency regulation of the power grid. In order to achieve collaborative control of the distributed charge station cluster, as shown in FIG. 6, a virtual charge station is taken as a leader and the desired states k_{c0} and k_{pq0} are predefined. Other n charge stations in a network are referred to as followers. In order to ensure the desired state of the leader is not affected, the state information of the leader is assumed to be able to affect the state of the followers whereas the state information of the followers cannot affect the state of the leader. The dynamic equation of the virtual leader is shown below:

$${\dot{q}}_{0} ( t ) = {p}_{0} ,$$

$${\dot{p}}_{0} = 0$$

where q₀(t) ∈ [symbol] ^{m}, 0<p₀∈ [symbol] ^{m} refers to an available capacity and a response power for frequency regulation of the virtual leader charge station. The virtual leader consistency algorithm considers the consistency of k_{c}(t) and achieves distributed collaborative control. The secondary frequency regulation response power is allocated among the charge stations based on the frequency regulation cost and controllable capacity, so as to reduce the frequency regulation cost under the precondition of ensuring the frequency regulation effect. The consistency control problem can be solved in two steps.

1) The power grid scheduling center updates the desired states p₀ and q₀ of the leader based on the system frequency state.

2) Based on the input of the designed consistency collaboration control, the state variables of the followers in the system are enabled to follow the state of the leader through the topological network.

When the collaborative control of the multiple charge stations is achieved, the frequency regulation cost and the frequency information will be exchanged based on the network topology matrix. The virtual leader can receive an instruction from an upper-level scheduling center. Therefore, the frequency regulation power can be adjusted and allocated based on the collaborative variables k_{ci} and k_{pqi} to achieve the consistency. The proposed collaborative control strategy can, in a case of occurrence of frequency disturbance, use the virtual leader and limited communication links to achieve weakly-centralized control of the charge station cluster. During steady operation, the charge stations can also receive an upper-level scheduling instruction to employ centralized control under the conventional charge station control framework.

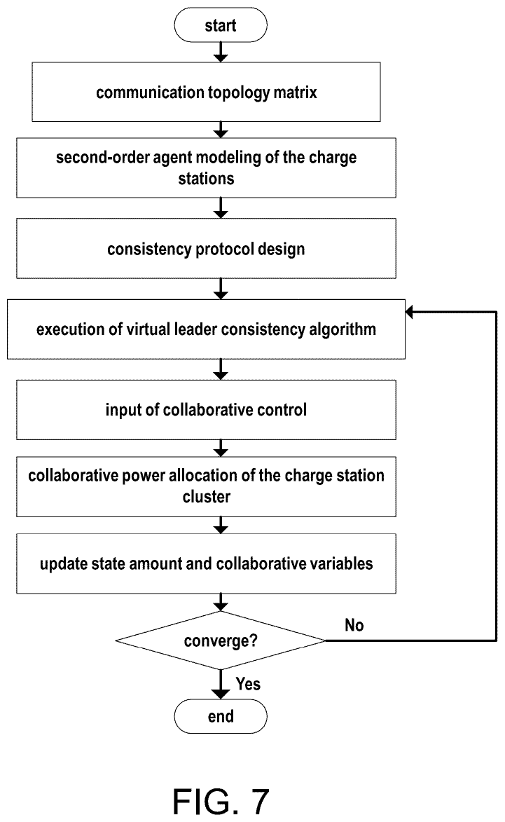

During a frequency control process, by using the virtual leader consistency algorithm, the frequency regulation cost and the frequency deviation can be reduced. The result of the algorithm is fed back to the controlled charge station to change the power output of the charge station and further affect the state of the islanded micro-grid, thus forming a closed-loop real-time iteration. The solution of the consistency algorithm depends on the restoration of the micro-grid frequency. But, in the dynamic process of the frequency restoration, the collaborative variables k_{ci} and k_{pqi} in the consistency protocol also gradually converge, with the flow shown in FIG. 7.

The cycle process and convergence steps are as follows: at the time of occurrence of disturbance, the charge station cluster, based on the designed consistency protocol and the virtual leader algorithm, executes control algorithm to update a control input of each charge station VSG. In each charge station VSG, the frequency regulation response power is collaboratively allocated, which further imposes impact on the frequency. Further, the state amount (i.e. charge and discharge power), the frequency regulation cost rate and the collaborative variable of power capacity coefficient of each charge station VSG are updated. Based on frequency restoration, it is determined whether stable state is achieved. Due to the design of the consistency protocol and collaborative variables, when the system frequency is restored to stable, the collaborative variables will undoubtedly converge.

Final output: after convergence, the output collaborative variables of the charge stations tend to be consistent, and each charge station outputs a frequency regulation power corresponding to the consistency algorithm.

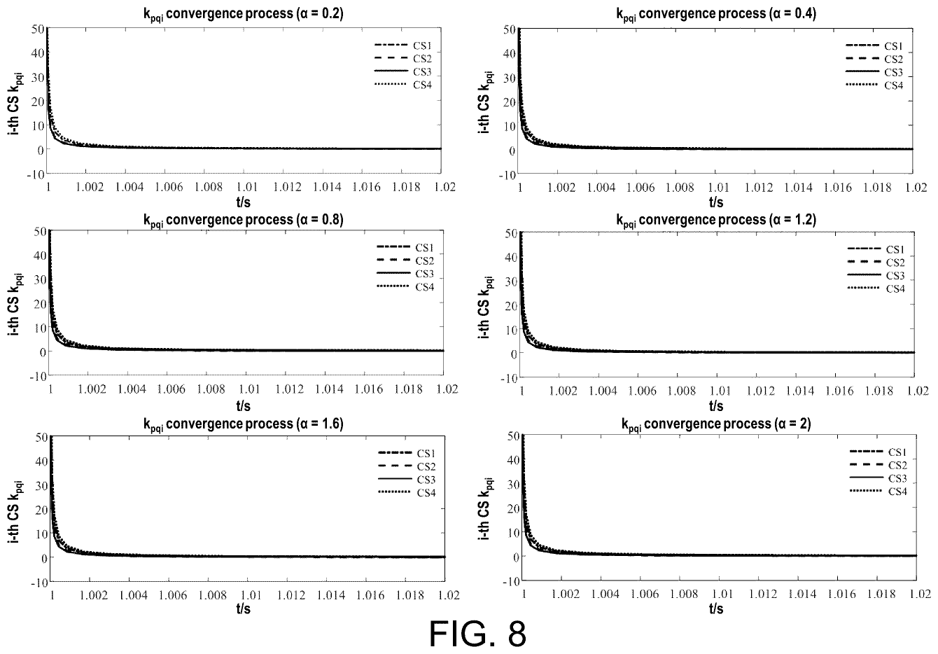

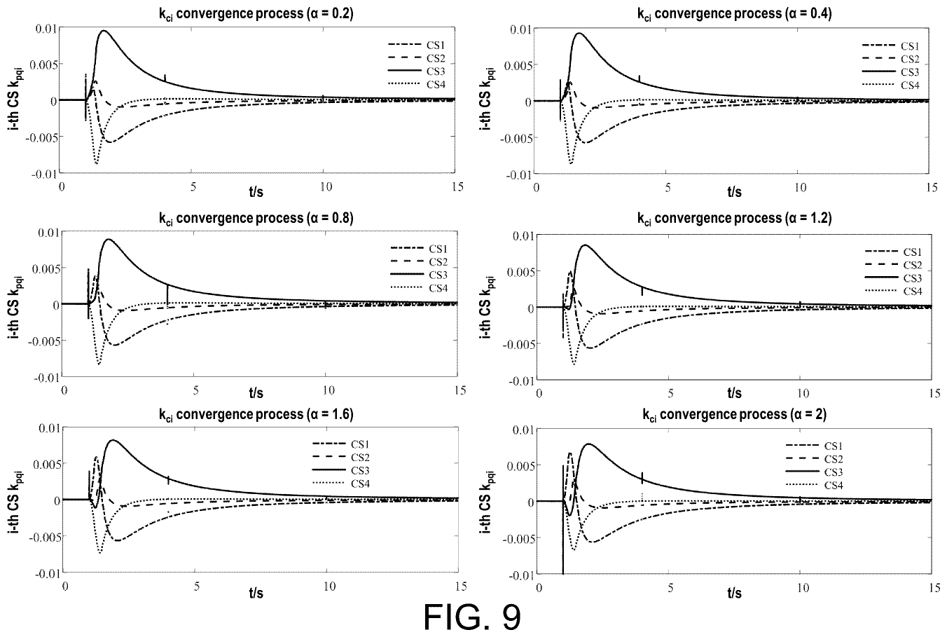

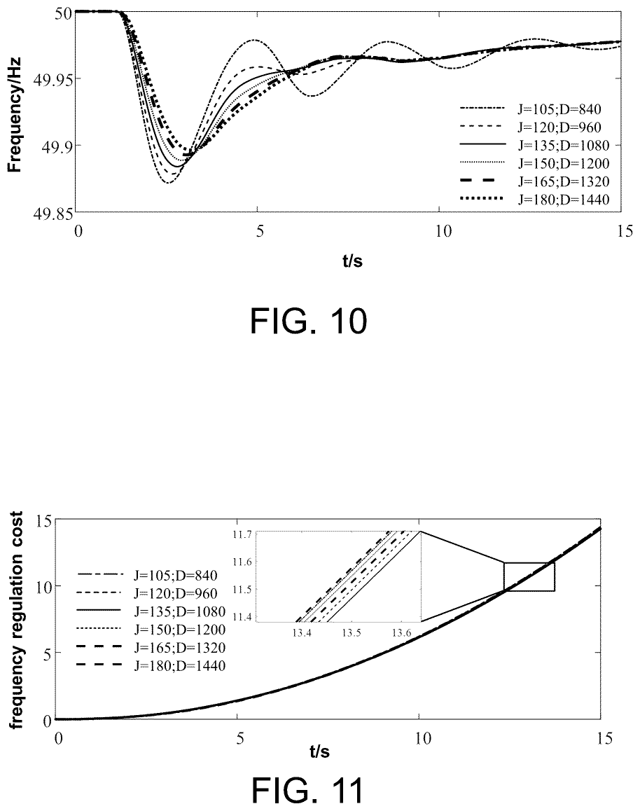

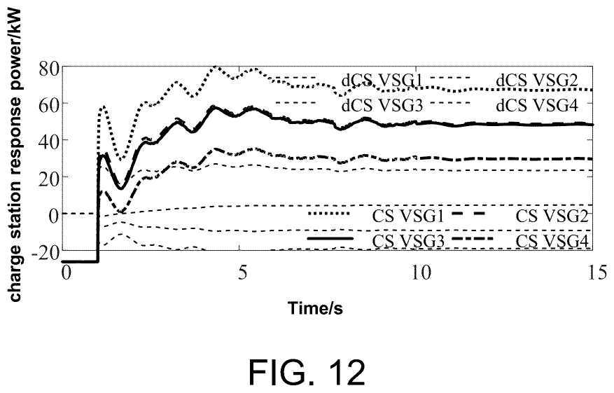

At step 5, the parameters used in the examples are as shown in Table 1, and the convergence processes of the power capacity coefficient and the relative frequency regulation cost coefficient, the frequency, the frequency regulation cost and the output of each charge station are as shown in FIGS. 8, 9, 10, 11 and 12.

TABLE 1

| Parameter names | Values | |
|---|---|---|
| Micro-grid inertia/damping coefficient | 8.22/5 | |
| CS VSG maximum power | 100/140/160/100 | |
| CS VSG inertia time constant J_{i, 0} | 100/200/300/400 | |
| CS VSG damping coefficient D_{fi, 0} | 120/120/120/120 | |
| VSG no-load electromotive force E₀ | 320 | V |
| VSG machine-end voltage Uₗ | 311 | V |
| Filtering inductance L_{f} | 0.001 | |
| Reference power | 1000 | kW |

Therefore, the weakly-centralized frequency regulation control system of the charge station cluster can achieve collaborative frequency regulation response and restore the frequency and hence improve the frequency stability of the power grid. The proposed method can be applied to aggregation and collaborative control of the charge stations. The controlled charge stations can respond to the frequency disturbance as a response to a load requirement in a distributed network. The basic prerequisite for the proposed large-scale application method of electric vehicles is the modeling of the charge stations. During the modeling process, it is necessary to distinguish the number and the limitation of the adjustable electric vehicles. Furthermore, based on communication link and electric topological structure of the charge stations, as a prerequisite, a network topology matrix is established so as to generate a collaborative relationship. In the collaborative relationship of the frequency response process, each charge station can achieve weakly-centralized and even decentralized collaborative control.

On one hand, the present disclosure provides a computer program product, including a computer program, where the computer program is stored in a non-transient computer readable storage medium, and executed by a processor to cause a computer to perform the above control method.

On the other hand, the present disclosure further provides a non-transient computer readable storage medium, storing a computer program, where the computer program is executed by a processor to perform the above control method.

The above-described apparatus embodiments are merely illustrative, where the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the embodiments. Persons of ordinary skill in the arts can understand and carrying out the present disclosure without making creative work.

Based on the descriptions of the above embodiments, the technicians in the arts can clearly understand that each embodiment can be implemented by software plus necessary general hardware platform, or by hardware. Based on such understanding, the above technical solutions essentially or a part contributing to the prior art may be embodied in the form of a software product, and the software product is stored in a computer readable storage medium such as ROM/RAM, magnetic diskette and compact disk and the like and includes several instructions for enabling a computer device (such as a personal computer, a server or a network device) to execute the method of each embodiment or some parts of the embodiment of the present disclosure.

Finally, it should be noted that the above embodiments are used only to describe the specific technical solutions of the present disclosure and not to limit the present disclosure. Although detailed descriptions are made to the present disclosure by referring to the preceding embodiments, those skilled in the art should understand that any person of this prior art may still make modifications to the technical solutions recorded in the above embodiments or make equivalent substitutions to part of technical features therein within the technical scope of the present disclosure. Such modifications and substitutions will not cause the essence of the corresponding technical solutions to depart from the spirit and scope of the technical solutions of the embodiments of the present disclosure.

What is claimed is:

1. A weakly-centralized frequency regulation control method of a charge station cluster based on virtual leader, comprising:
collecting data of wind power, photovoltaic and random load systems, comprising real-time outputs of wind power, photovoltaic, resident loads and each charge station within a controlled region;
at the time of occurrence of disturbance, based on a virtual synchronous generator control architecture of charge stations, in accordance with a consistency protocol and a virtual leader algorithm, executing, by the charge station cluster, a control algorithm to update a control input of each charge station, collaboratively allocate a frequency regulation response power in each charge station, and update a state amount of each charge station comprising a charge and discharge power, a collaborative variable of frequency regulation cost rate, and a collaborative variable of power capacity coefficient;
based on frequency restoration, determining whether a stable state is achieved; and
outputting the collaborative variables of each charge station and frequency regulation power of each charge station when a system frequency is restored to stable.

2. The weakly-centralized frequency regulation control method of claim 1, wherein a control strategy of a virtual synchronous generator (VSG) of the charge stations is defined as comprising a control strategy of a rotor motion equation and an electromagnetic transient equation of a synchronous generator, which specifically comprises the followings: after receiving a Pₘ input power instruction, the VSG determines, by a torque equation, a rotational angular velocity of a virtual rotor and performs subtraction operation on the rotational angular velocity and a rated rotational angular velocity ω_{N} to obtain an angular acceleration of a virtual power angle δ, and obtains the virtual power angle by integration, wherein based on power angle characteristics, an output power Pₑ of the VSG is calculated in the following formula:
$${P}_{e} = \frac{{E}_{0} U}{{X}_{f}} sin δ$$
wherein E₀ is a no-load electromotive force of the VSG, U is an output end voltage of the VSG, and X_{f} is a filtering reactance.

3. The weakly-centralized frequency regulation control method of claim 1, wherein, the charge stations are involved in frequency regulation and an EV-f controller feedback compensation step is added to a power-frequency controller to correct a reference value of a VSG input mechanical power, which specifically comprises the followings:
$${P}_{m} = {P}_{ref} + Δ {P}_{ev - f}$$
wherein Pₘ is a master frequency regulation instruction of the charge station; P_{ref} is a rated power at a time of no consideration of frequency regulation, and ΔP_{ev-f}, is a compensation power output by the EV-f controller feedback compensation step,
ΔP_{ev-f} is valued in a range of [ΔP_{e ev-f min}, ΔP_{ev-f max}], and ΔP_{ev-f min} and ΔP_{ev-f max} are calculated in the following formulas:
$${P}_{ev - fmin} ( τ ) = {\sum }_{i = 1}^{N} {P}_{i}^{+} ( τ ) , ∀ τ$$
$${P}_{ev - fmax} ( τ ) = {\sum }_{i = 1}^{N} {P}_{i}^{-} ( τ ) , ∀ τ .$$

4. The weakly-centralized frequency regulation control method of claim 1, wherein, a collaborative topology design control method of the consistency protocol among multiple charge stations comprises:
establishing a second-order agent system of the charge stations;
establishing collaborative variables comprising a power capacity coefficient and a relative frequency regulation cost coefficient, and defining a frequency regulation cost and a relative frequency regulation cost coefficient of an electric vehicle;
designing a consistency protocol and executing control based on the designed consistency protocol.

5. The weakly-centralized frequency regulation control method of claim 1, wherein in a second-order agent system, the collaborative variable of frequency regulation cost rate of the charge stations to be enabled the same as the collaborative variable of power capacity coefficient is aimed, and achieve frequency regulation of a power grid; one virtual charge station is taken as leader, desired states and are pre-defined, other n charge stations in a network are referred to as followers, and a secondary frequency regulation response power is allocated among the charge stations based on a frequency regulation cost and a controllable capacity, which specifically comprises:
based on a system frequency state, updating, by a power grid scheduling center, desired states and of the leader;
based on the input of a designed consistency collaborative control, enabling state variables of the followers in the system to follow the state of the leader through a topological network.

6. The weakly-centralized frequency regulation control method of claim 1, wherein the collaborative variables comprise a power capacity coefficient k_{pqi} and a relative frequency regulation cost coefficient k_{ci}, wherein,
the power capacity coefficient k_{pqi}
$${k}_{pqi} = {p}_{i} / {q}_{i} ,$$
$${k}_{pq 0} = {P}_{N} / {\sum }_{j = 1}^{n} {q}_{j}$$
relative frequency regulation cost coefficient
$${k}_{ci} ( t ) = [ {cost}_{cs , i} ( t ) - \frac{1}{n} {\sum }_{i = 1}^{n} {cost}_{cs , i} ( t ) ] / {\sum }_{i = 1}^{n} {cost}_{cs , i} ( t ) , {k}_{c 0} = 0$$
wherein k_{pq0} is a power capacity coefficient of the virtual leader, which means an average value of the power capacity coefficients at the time of collaboration of n charge stations, P_{N} is a master frequency regulation power instruction for collaboration of the charge stations as well as an input of a consistency collaboration control algorithm, pᵢ is a real-time power of the i-th charge station, qᵢ is a controllable capacity of the i-th charge station, k_{pqi} is a power capacity coefficient of the i-th charge station, k_{ci} is a relative frequency regulation cost coefficient of the i-th charge station, k_{c0} is a relative frequency regulation cost coefficient of the virtual leader, n is a number of the charge stations in the charge station cluster, cost_{cs,i} is a frequency regulation cost rate of the i-th charge station, cost_{cs,i} is a frequency regulation cost rate, P_{k,i}^{cha} is a charge power of EVk in the i-th charge station, SoCₖ^{emin} and SoCₖ^{emax} are desired SoC upper limit and lower limit of EVk in the i-th charge station, E_{k,i}ⁿ is battery rated capacity of EVk in the i-th charge station, Kᵢ is a total number of adjustable EVs in the i-th charge station, k_{c0} is a relative Frequency Regulation (FR) cost rate of the virtual leader, which means providing a reference value of the frequency regulation cost rate in the collaboration of n charge stations when value of k_{c0} is 0.

7. The weakly-centralized frequency regulation control method of claim 5, wherein the frequency regulation cost cost_{cs,i}(t) of an electric vehicle is calculated as follows:
$${cost}_{cs , i} ( t ) = {\sum }_{k = 1}^{{K}_{i}} \frac{{P}_{max} - {P}_{k , i}^{cha} ( t )}{( {SoC}_{k , i}^{max} - {SoC}_{k , i}^{min} ) {E}_{k , i}^{n}}$$
wherein cost_{cs,i} is a frequency regulation cost rate, P_{k,i}^{cha} is a charge power of EVk in the i-th charge station, SoCₖ^{emin} and SoCₖ^{emax} are desired SoC upper limit and lower limit of EVk in the i-th charge station, E_{k,i}ⁿ is a battery rated capacity of EVk in the i-th charge station, and Kᵢ is a total number of adjustable EVs in the i-th charge station.

8. The weakly-centralized frequency regulation control method of claim 1, wherein,
based on the power capacity coefficient k_{pq} and a relative FR cost rate k_{c}, a following consistency control protocol is established:
$${u}_{i} ( t ) = {\sum }_{j = 1}^{n} {a}_{ij} ( sign ( {k}_{pqi} ( t ) - {k}_{pqj} ( t ) ) ) - {g}_{i} ( sign ( {k}_{pqi} ( t ) - {k}_{pq 0} ( t ) ) ) - α {P}_{N} {\sum }_{j = 1}^{n} {a}_{ij} ( sign ( {k}_{cj} ( t ) - {k}_{ci} ( t ) ) ) - {g}_{i} ( sign ( {k}_{c 0} ( t ) - {k}_{ci} ( t ) ) )$$
wherein sign(.) represents a symbol function, α is a control gain, k_{c0}(t)=0 for α=2, P_{N} is a master FR power instruction for collaboration of the charge stations as well as an input of a collaborative control; a consistency of the control algorithm is embodied in maintaining a ratio of the power capacity coefficient as consistent after frequency stabilization, such that a total frequency regulation cost in a process of the frequency restoration process is minimized; aᵢⱼ represents whether a 0-1 logic variable is communicably collaborated between the i-th charge station and the j-th charge station; in case of collaboration, aᵢⱼ=1 and otherwise aᵢⱼ=0; gᵢ represents whether the i-th charge station receives state information of the virtual leader; if yes, gᵢ=1, and otherwise gᵢ=0, k_{pqi} is a power capacity coefficient of the i-th charge station, k_{pq0} is a power capacity coefficient of the virtual leader, k_{ci} is a relative frequency regulation cost coefficient of the i-th charge station, k_{c0} is a relative frequency regulation cost coefficient of the virtual leader, wherein when x>0, sign (x)=1; when x=0, sign (x)=0; when x<0, sign (x)=−1.

9. A non-transient computer readable storage medium, storing a computer program, wherein the computer program is executed by a processor to perform the control method of claim 1.

10. A computer program product, comprising a computer program, wherein the computer program is executed by a processor to perform the control method of claim 1.
